(19) United States
(12) Patent Application Publication
(10) Pub. No.: US 2014/0293847 A1
(43) Pub. Date: Oct. 2, 2014

(54) DATA PROCESSING METHODS PERFORMED BY UMTS-FDD DEVICE WITH TFCI EARLY TERMINATION

(71) Applicant: MEDIATEK INC., Hsin-Chu (TW)

(72) Inventor: Jeng-Yi Tsai, Hsinchu City (TW)

(73) Assignee: MEDIATEK INC., Hsin-Chu (TW)

(21) Appl. No.: 14/108,375

(22) Filed: Dec. 17, 2013

Related U.S. Application Data
(60) Provisional application No. 61/807,052, filed on Apr. 1, 2013.

(51) Int. Cl. H04L 5/00; H04L 5/14

(52) U.S. Cl. CPC H04L 5/0019; H04L 5/14
USPC 370/281

(57) ABSTRACT

A data processing method performed by a Universal Mobile Telecommunications System Frequency Division Duplexing (UMTS-FDD) device includes at least the following steps: receiving a control frame from a dedicated physical control channel (DPCCH) and a data frame from a dedicated physical data channel (DPDCH), wherein the control frame includes n slots, and each slot thereof includes at least a portion of a transport format combination indicator (TFCI) codeword, wherein n is a positive integer, and the TFCI codeword is encoded from TFCI content for indicating a transport format combination of the data frame; and when m of the n slots are received, starting to decode the data frame according to the m slots, wherein m is a positive integer and less than n.

### CROSS REFERENCE TO RELATED APPLICATIONS

This Application claims priority of U.S. Provisional Application No. 61/807,052, filed on Apr. 1, 2013, the entirety of which is incorporated by reference herein.

### BACKGROUND

The present disclosure relates generally to a Universal Mobile Telecommunications System Frequency Division Duplexing (UMTS-FDD) communications system, and in particular, to a data decoding method performed by a communications device with TFCI early termination.

In a UMTS-FDD environment, Orthogonal Variable Spreading Factor (OVSF) is an implementation of Code Division Multiple Access (CDMA) wherein, before each signal is transmitted, the signal is spread over a wide spectrum range through the use of an OVSF code. OVSF codes are mutually orthogonal to each other. Then the signal is scrambled with some scrambling codes to identify different Node Bs in downlink (DL) or to identify different user equipments (UEs) in uplink (UL).

The flexible spreading factor scheme employed by UMTS-FDD Release 99 allows an uplink (UL) dedicated physical data channel (DPCCH) to dynamically switch its spreading factor between a set of spreading factors, specified by minimum spreading factor SFmin. The spreading factor set is a subset of 4, 8, 16, 32, 64, 128, and 256 that started from SFmin. For instance, a Node B is to perform pre-de-spreading over all possible spreading factors upon DPDCH. After Transport Format Combination Indicator (TFCI) content is derived from a dedicated physical control channel (DPCCH), the Node B is to perform de-rate matching and decoding process upon the pre-de-spread result which correlates to the spreading factor indicated by the TFCI content.

It is a precondition that the TFCI content is in no way to be credibly derived whenever the DPCCH frame is not completely received, which means the data received from the DPDCH has to be temporarily buffered. In the prior art, the data decoding process will not start until the 10-bit TFCI information is formally calculated by utilizing the complete 30-bit TFCI codeword obtained from the received control radio frame. The conventional flow of the UMTS-FDD receiver therefore has issues with respect to such as power dissipation and system capacity.

Alternative designs may adopt customized specification such as employing an additive physical channel dedicated for TFCI transmission, or shortening the TFCI codeword length and enlarging the TFCI field of each slot. A feasible means which is UMTS-FDD compatible is still required for mitigating the above-mentioned issues.

### SUMMARY

In accordance with exemplary embodiments of the present invention, a data decoding method performed by a communications device is proposed to solve the above-mentioned problems.

According to a first aspect of the present invention, a data processing method performed by a Universal Mobile Telecommunications System Frequency Division Duplexing (UMTS-FDD) device is disclosed. The method comprises: receiving a control frame from a dedicated physical control channel (DPCCH) and a data frame from a dedicated physical data channel (DPDCH), wherein the control frame comprises n slots , and each slot thereof comprises at least a portion of a transport format combination indicator (TFCI) codeword, wherein n is a positive integer, and the TFCI codeword is encoded from TFCI content for indicating a transport format combination of the data frame; and when m slots of the n slots are received, starting to decode the data frame according to the m slots, wherein m is a positive integer and less than n.

According to a second aspect of the present invention, a data processing method performed by a UMTS-FDD device is disclosed. The method comprises: generating a control frame and a data frame, wherein the control frame comprises n slots only, and each of q slots of the n slots comprises 2 bits of a transport format combination indicator (TFCI) codeword, where q and n are positive integers and n is greater than q, and the TFCI codeword is encoded from TFCI content for indicating a transport format combination of the data frame; and transmitting the control frame through a dedicated physical control channel (DPCCH) and the data frame through a dedicated physical data channel (DPDCH).

According to a third aspect of the present invention, a data processing method performed by a UMTS-FDD device is disclosed. The method comprises: receiving a control frame from a dedicated physical control channel (DPCCH) and a data frame from a dedicated physical data channel (DPDCH), wherein the control frame comprises n slots only, and each of q slots of the n slots comprise 2 bits of a transport format combination indicator (TFCI) codeword, where q and n are positive integers and n is greater than q, and the TFCI codeword is encoded from an original TFCI contentdata for indicating a transport format combination of the data frame; and decoding the data frame according to a derived TFCI contentdata obtained from the control frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a system diagram of a UTRAN in a UMTS according to an embodiment of the invention.

FIG. 2 is a diagram illustrating the TFCI structure in a radio frame.

FIG. 3 is a flowchart illustrating a data processing method performed by a UMTS-FDD device according to an embodiment of the present invention.

FIG. 4 is a flowchart illustrating a data processing method performed by a UMTS-FDD device according to another embodiment of the present invention.

FIG. 5 is a flowchart illustrating a data processing method performed by a UMTS-FDD device according to still another embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

Since 1999, the 3^{rd} Generation Partnership Project (3GPP) has released several versions of spread-spectrum-based mobile communications system, including Universal Mobile Telecommunications Systems (UMTS), High-Speed Packet Access (HSPA), and High-Speed Packet Access+ (HSPA+) . The following discussions are based on the UMTS Frequency-Division Duplexing (FDD) communications system, which is also called UMTS-FDD Release 99 to discriminate from later releases which include new features.

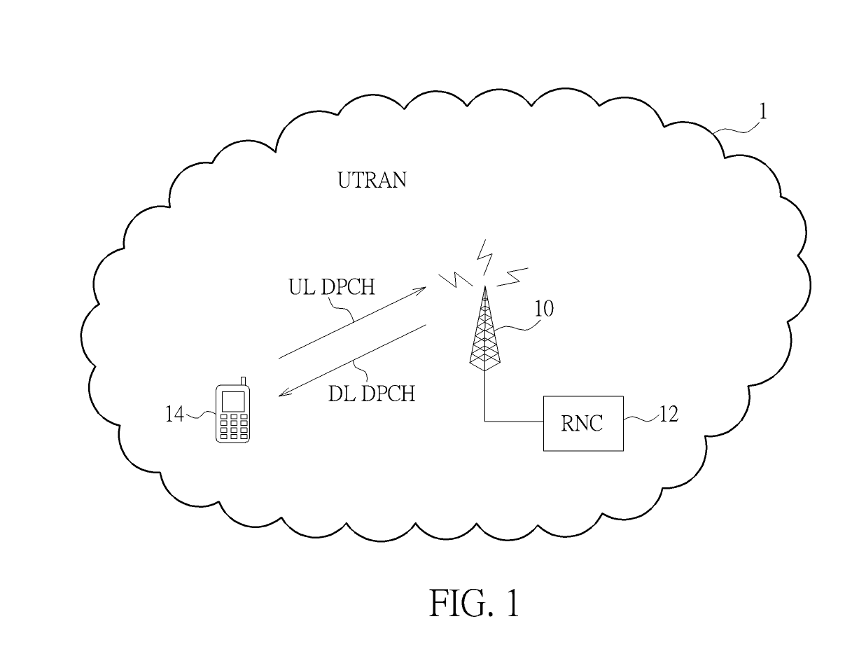

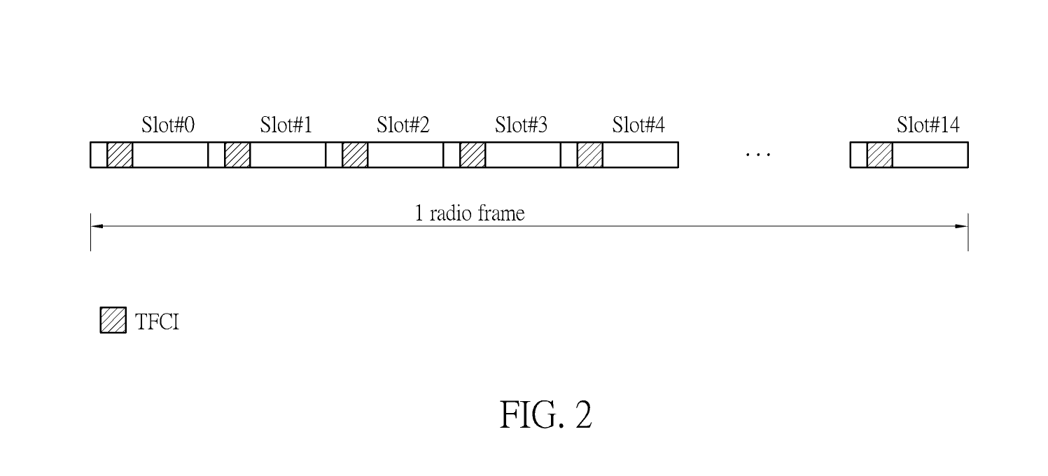

FIG. 1 is a system diagram of a UMTS Terrestrial Radio Access Network (UTRAN) 1 in a UMTS according to an embodiment of the invention. The UTRAN 1 has a Node B 10 and a radio network controller (RNC) 12. For a circuit-switched (CS) service such as a voice or speech service, a user equipment (UE) 14 can communicate with the Node B 10 by communications channels including an uplink dedicated physical channel (UL DPCH) and a downlink dedicated physical channel (DL DPCH) . The UE 14 may be a notebook computer with a dongle device, a mobile phone, or other mobile communications device capable of performing wireless communications with the Node B 10 in UTRAN 1. The RNC 12 is connected to and controls a plurality of Node Bs. The Node B 10 includes a transmitter (not shown), a receiver (not shown) and a control circuit (not shown) . The UTRAN 1 implements a proposed early termination TFCI scheme for the circuit-switched service on the Node B 10 and the UE 14 according to various embodiments of the invention, as detailed in FIGS. 2-5. By way of example, the disclosed early termination TFCI scheme is operational for either UL DPCH or DL DPCH.

In a case of UL DPCH decoding, a TFCI indicates a combination of a rate matching scheme and a channel coding scheme that will be required in an uplink dedicated physical control channel (UL DPCCH) for decoding an uplink dedicated physical data channel (UL DPDCH). According to the UMTS-FDD Release 99 standard, the TFCI content is converted into 10 information bits for a receiver to execute a data de-rate matching and decoding process, and the 10-bit TFCI {a₀, a₁, a₂, . . . , a₉} is further encoded into a 32-bit TFCI codeword {b₀, b₁, b₂, . . . , b₃₁} by a (32, 10) sub-code of second order Reed-Muller code. The details of the Reed-Muller code encoding process can be found by referring to the UMTS-FDD Release 99 standard, and are therefore omitted here for brevity. In normal mode, the first 30 bits of the TFCI codeword (2 bits/slot*15 slots) are filled in one DPCH frame as shown in FIG. 2, which is a diagram illustrating the TFCI structure in a radio frame. The TFCI may change every radio frame, which means the Node B 10 has to decode TFCI content from the UL DPCCH data before decoding the UL DPDCH data for every radio frame.

Conventionally, when a complete radio frame is received (30 bits of the 32-bit TFCI codeword are completely collected), the receiver is able to derive the TFCI content and then decode data in light of the derived TFCI content. For a case of unique TFCI for frames within 1 minimum transmission time interval (TTI), strategies such as applying the TFCI decoding result of the first frame for the remaining frames of this minimum TTI, or trying various combinations on the TFCI in these frames to revise the TFCI decoding result of the first frame may be employed in practice. The performance will be affected, however, since the data de-rate matching and decoding process must start after one radio frame. For Adaptive Multi-Rate (AMR) speech service, the number of TFCI candidates is up to 12 and the TFCI content is converted into the log 2(12) ˜=4 LSBs of 10 information bits, while the rest of bits are always padded with bit “zero”. As a result, the effective coding rate for speech service is 4/30. Assume at least 1/3 coding rate is required for decoding the TFCI codeword in normal situations (precluding the case where SNR is extremely poor which may also lead to failure to decode by using the complete TFCI codeword). Only 4*3=12 bits=6 slots are required in light of the characteristics of the Reed-Muller code, which means the data decoding process may be started upon receiving 6 slots rather than 15 slots. For example in uplink, the Node B 10 may perform de-rate matching and decode the data when 6 slots are received before the complete 15 slots of data and TFCI codeword of a radio frame is received. In this way, the transmission power and the introduced interference may be reduced, and the system capacity is upgraded to a higher level.

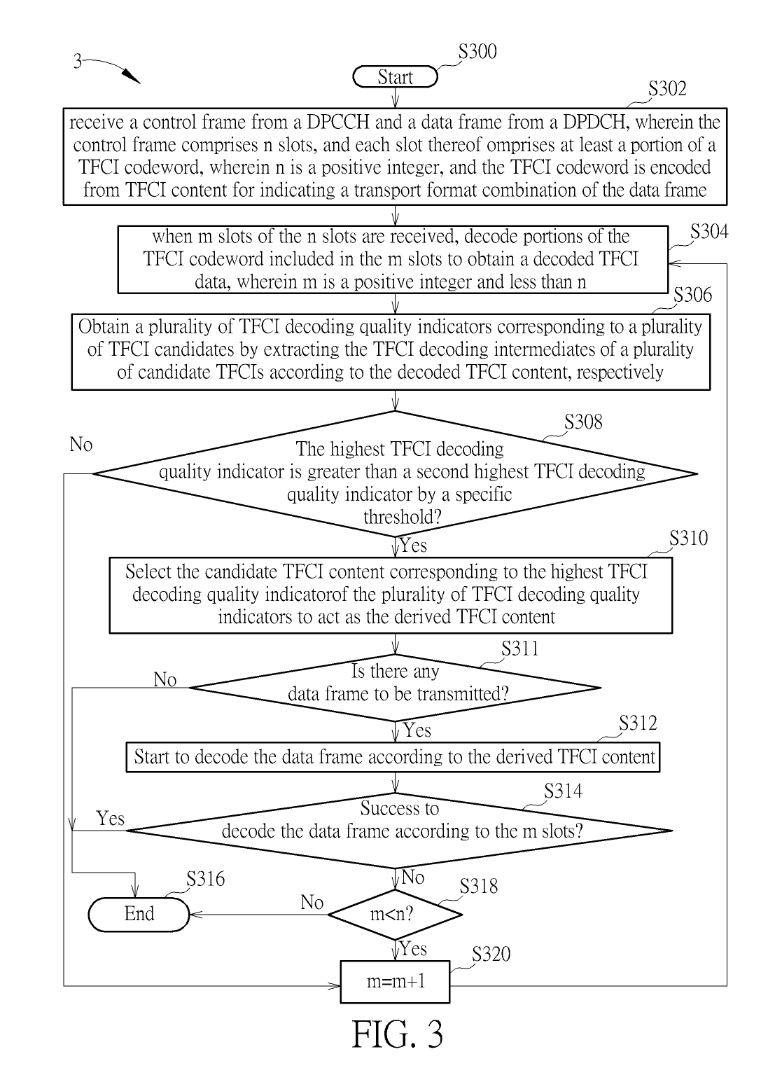

FIG. 3 is a flowchart illustrating a data processing method performed by a UMTS-FDD device according to an embodiment of the present invention. Provided that substantially the same result is achieved, the steps of the flowchart shown in FIG. 3 need not be in the exact order shown and need not be contiguous; that is, other steps can be intermediate. Some steps in FIG. 3 may be omitted according to various embodiments or requirements. The data processing method 3 may include the following steps.

Step S300: Start.

Step S302: Receive a control frame from a DPCCH and a data frame from a DPDCH, wherein the control frame comprises n slots, each slot thereof comprises at least a portion of a TFCI codeword, n is a positive integer, and the TFCI codeword is encoded from TFCI content for indicating a transport format combination of the data frame.

Step S304: When m slots of the n slots are received, decode portions of the TFCI codeword included in the m slots to obtain a decoded TFCI data, wherein m is a positive integer and less than n.

Step S306: Obtain a plurality of TFCI decoding quality indicators corresponding to a plurality of TFCI candidates by extracting the TFCI decoding intermediates of a plurality of candidate TFCIs according to the decoded TFCI content, respectively.

Step S308: The highest TFCI decoding quality indicator is greater than a second highest TFCI decoding quality indicator by a specific threshold? If yes, go to step S310, else go to Step S320.

Step S310: Select the candidate TFCI content corresponding to the highest TFCI decoding quality indicator of the plurality of TFCI decoding quality indicators to act as the derived TFCI content.

Step S311: Is there any data frame to be transmitted? If yes, go to step S312, else go to step S316.

Step S312: Start to decode the data frame according to the derived TFCI content.

Step S314: Success to decode the data frame according to the m slots? If yes, go to step 316, else go to step 318.

Step S316: End.

Step S318: m<n? If yes, go to step 320, else go to step 316.

Step S320: m=m+1. Go to Step 304.

At Step S300, assume a UMTS-FDD device (e.g. the UE 14 or the Node B 10) transmits a radio frame via a UL/DL DPCH. A control frame and a data frame are included, which are transmitted respectively, through a DPCCH and a DPDCH. Another UMTS-FDD device with an early termination TFCI scheme which has a link built with the UMTS-FDD device mentioned above receives the control frame from the DPCCH and the data frame from the DPDCH at Step S302. The DPCCH may be an uplink DPCCH (UL DPCCH)/downlink DPCCH (DL DPCCH) and the DPDCH may be an uplink DPDCH (UL DPDCH)/downlink DPDCH (DL DPDCH). The control frame consists of 15 slots, and each slot thereof comprises at least a portion of a TFCI codeword in this embodiment. For typical speech service, the first 30 bits of the 32-bit TFCI codeword (2 bits/slot*15 slots) will fill one control frame as shown in FIG. 2. The TFCI codeword is encoded from TFCI information bits (10 bits) by the Reed-Muller code for indicating a transport format combination of the data frame. It should be noted that, in the case of a 15-slot control frame, the parameter n in Step S302 does not have to be 15. In practice, n may be a value smaller than 15, which also falls within the scope of the present invention.

The principles of configurations of the parameter m of Step S304 have been disclosed in previous paragraphs; the details thereof are omitted here for brevity. According to the TFCI early termination scheme mentioned above, m can be configured to 6; i.e. if 6 slots are received, TFCI content will be decoded according to the 6 slots. Theoretically, except for a worst case, first 12 bits of the TFCI codeword is a reasonable value for restoring the correct 4 LSB (in the case of speech data transmission) of the TFCI content in light of information theory and the Reed-Muller code (Step S304). During the decoding procedure, we may extract the TFCI decoding quality indicators for a plurality of TFCI candidates respectively (Step S306). The TFCI candidates are determined in advance according to the UMTS-FDD standard; for example, 6 categories of TFCI candidates have to be prepared in the case of typical speech service. If the highest TFCI decoding quality indicator is greater than a second highest TFCI decoding quality indicator by a specific threshold (e.g. 1 dB or in other comparison units), the TFCI candidate corresponding to the highest TFCI decoding quality indicator will be selected to act as the derived TFCI content (Step S310).

After the TFCI content is derived, the data frame decoding process can be started according to information brought by the derived TFCI content (Step S312). If the TFCI content indicates that there is no data frame in this minimum TTI, Step S316 will be entered. Otherwise if the data frame is decoded according to the 6 slots and the associated error detection checking, such as CRC code, indicates that the decoding process is error free, the radio frame will be claimed as successfully decoded, and Step S316 will be entered. If the data frame is decoded according to the 6 slots and the associated error detection checking, such as CRC code, indicates that the decoding process is not error free, Step S318 will be entered. Since the failure of decoding maybe induced by the wrong TFCI content (i.e. the derived TFCI content is not the same with the transmitted TFCI content), more bits of the TFCI codeword should be taken into consideration to enhance the accuracy of the derived TFCI content. If the number of slots used for deriving the derived TFCI content is less than the number of all slots in a radio frame (i.e. m<n), the decoding process should be executed once more by using the derived TFCI which is derived by utilizing more slots. For instance, if one more slot is received, there are 7 slots available for determination of the TFCI content, and the derived TFCI content will be generated based on the 7 slots. The steps following Step S306 thus will be repeated once more until the correct data frame is decoded, or all of the 15 slots are used for determining the derived TFCI content.

It should be noted that the initial value of m is not limited to 6, and m may be a number between 1 and 14 in practice. In the case where Transmission Time Interval (TTI) is considered, when the minimum TTI is 2 radio frames, m may be 1, 2, 3, . . . , 14, or 16, . . . , 29, wherein 15 and 30 are existing solutions. Further, the increment step size is not limited to 1 as shown in Step S320. For example, in the second round, 6+2=8 slots maybe taken into account for deriving the derived TFCI data rather than using 7 slots. Moreover, the early termination TFCI scheme may be employed by either UL DPCH or DL DPCH.

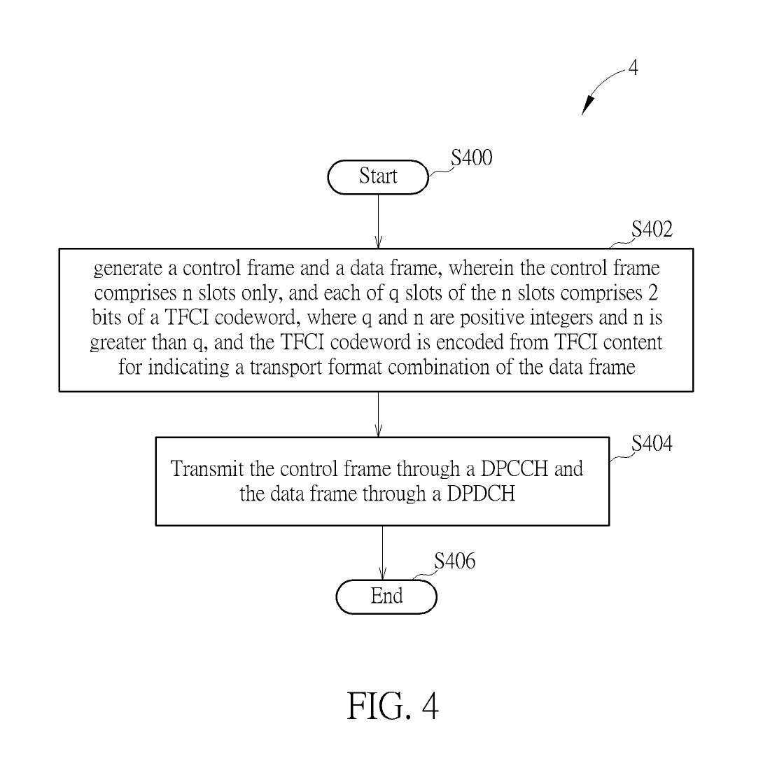

FIG. 4 is a flowchart illustrating a data processing method performed by a UMTS-FDD device according to another embodiment of the present invention. Provided that substantially the same result is achieved, the steps of the flowchart shown in FIG. 4 need not be in the exact order shown and need not be contiguous; that is, other steps can be intermediate. Some steps in FIG. 4 may be omitted according to various embodiments or requirements. The data processing method 4 may include the following steps.

Step 400: Start.

Step 402: Generate a control frame and a data frame, wherein the control frame comprises n slots only, and each of q slots of the n slots may comprise 2 bits of a TFCI codeword, where q and n are positive integers, n is greater than q, and the TFCI codeword is encoded from TFCI content for indicating a transport format combination of the data frame.

Step 404: Transmit the control frame through a DPCCH and the data frame through a DPDCH.

Step 406: End.

Since the decoding process can be started before one radio frame is completely collected, the TFCI field of a portion of slots may be replaced by other control field for performance enhancement. For example, in UL, the TFCI field of a portion of slots may be replaced with a known pilot field to improve UL channel estimation quality and reduce transmission power. Therefore, in Step S402, a control frame and a data frame are both generated. Assuming that the control frame comprises 15 slots only, each 6 of the 15 slots thereof comprises 2 bits of a TFCI codeword. In a normal case, the receiver can successfully derive the correct TFCI data by only using 6 slots, and the TFCI of the remaining 9 slots can be utilized for carrying other information, such as acting as pilot field extension. When the minimum TTI is 2 radio frames, the TFCI filled by 9+15=24 slots may be utilized for carrying other information. Details of the corresponding receiver are described in the following paragraph. Please note, however, that the parameter q of Step S402 is not limited to 6, and can be adjusted based on the actual design considerations/requirements.

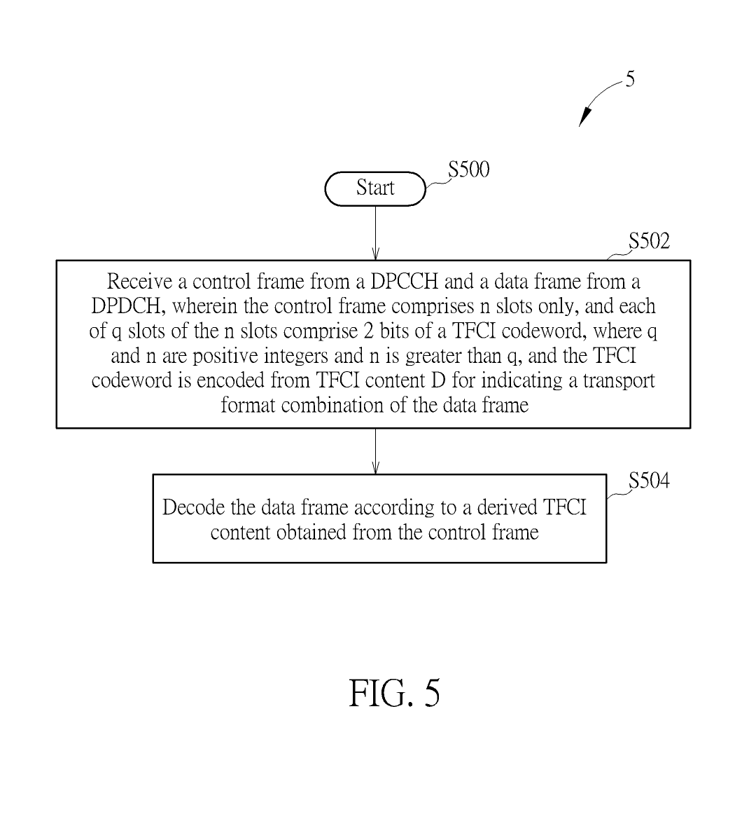

FIG. 5 is a flowchart illustrating a data processing method performed by a UMTS-FDD device according to still another embodiment of the present invention. Provided that substantially the same result is achieved, the steps of the flowchart shown in FIG. 5 need not be in the exact order shown and need not be contiguous; that is, other steps can be intermediate. Some steps in FIG. 5 may be omitted according to various embodiments or requirements. The data processing method 5 may include the following steps.

Step 500: Start.

Step 502: Receive a control frame from a DPCCH and a data frame from a DPDCH, wherein the control frame comprises n slots only, and each of q slots of the n slots may comprise 2 bits of a TFCI codeword, where q and n are positive integers and n is greater than q, and the TFCI codeword is encoded from TFCI content for indicating a transport format combination of the data frame.

Step 504: Decode the data frame according to a derived TFCI content obtained from the control frame.

Please note that, in the data processing method 5, not all slots of the control frame possess the TFCI field. Thus, at most q slots (e.g. 10 slots) will be used for deriving the TFCI content, while the number of slots in a frame is 15 (i.e. n=15). Steps S304-S320 of the method 3 shown in FIG. 3 may be employed by Step S504 through reasonable modifications. The decoding process will therefore be started before all q slots are completely received. Those skilled in the art should readily understand the method illustrated in FIG. 5 by referring to the method illustrated in FIG. 3; the details thereof are omitted here for brevity. Step S504 is not limited to the decoding process illustrated in FIG. 3. For instance, it is also feasible to start the decoding process after all of the q slots are completely received, and this also falls within the scope of the present invention.

In summary, the transport channel format information is able to be obtained earlier, so that data decoding can be started earlier without modifying the 3GPP Specifications. This provides the advantages of reduced transmission power and interference between users, as well as upgrading the system capacity.

As used herein, the term “determining” encompasses calculating, computing, processing, deriving, investigating, looking up (e.g. looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in an alternative embodiment, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing method performed by a Universal Mobile Telecommunications System Frequency Division Duplexing (UMTS-FDD) device, comprising:
receiving a control frame from a dedicated physical control channel (DPCCH) and a data frame from a dedicated physical data channel (DPDCH), wherein the control frame comprises n slots, and each slot thereof comprises at least a portion of a transport format combination indicator (TFCI) codeword, wherein n is a positive integer, and the TFCI codeword is encoded from TFCI content for indicating a transport format combination of the data frame; and
when m slots of the n slots are received, starting to decode the data frame according to them slots, wherein m is a positive integer and less than n.

2. The method of claim 1, wherein the DPCCH is an uplink DPCCH (UL DPCCH) and the DPDCH is an uplink DPDCH (UL DPDCH).

3. The method of claim 1, wherein the DPCCH is a downlink DPCCH (DL DPCCH) and the DPDCH is a downlink DPDCH (DL DPDCH).

4. The method of claim 1, wherein the step of starting to decode the data frame according to the m slots comprises:
generating a derived TFCI content according to the m slots; and
starting to decode the data frame according to the derived TFCI content.

5. The method of claim 4, wherein the step of generating the derived TFCI content according to the m slots comprises:
decoding portions of the TFCI codeword included in the m slots to obtain a decoded TFCI content;
extract a plurality of TFCI decoding quality indicators corresponding to a plurality of TFCI candidates according to the decoded TFCI content, respectively; and
selecting the candidate TFCI corresponding to a highest TFCI decoding quality indicator of the plurality of TFCI decoding quality indicators to act as the derived TFCI content.

6. The method of claim 5, wherein the step of selecting the candidate TFCI corresponding to the highest TFCI decoding quality indicator of the plurality of TFCI decoding quality indicators to act as the derived TFCI content comprises:
checking if the highest TFCI decoding quality indicator is greater than a second highest TFCI decoding quality indicator by a specific threshold; and
when the highest TFCI decoding quality indicator is greater than the second highest TFCI decoding quality indicator by the specific threshold, selecting the candidate TFCI corresponding to the highest TFCI decoding quality indicator of the plurality of TFCI decoding quality indicators to act as the derived TFCI content.

7. The method of claim 1, further comprising:
when decoding the data frame according to the m slots incurs a decoding failure, decoding the data frame again according to p slots, wherein the p slots include the m slots, and p is a positive integer greater than m.

8. The method of claim 7, wherein the step of decoding the data frame again according to the p slots comprises:
generating a derived TFCI content according to the p slots; and
decoding the data frame according to the derived TFCI content.

9. The method of claim 8, wherein the step of generating the derived TFCI content according to the p slots comprises:
decoding portions of the TFCI codeword included in the p slots to obtain a decoded TFCI content;
extract a plurality of TFCI decoding quality indicator corresponding to a plurality of TFCI candidates according to the decoded TFCI content respectively; and
selecting the candidate TFCI corresponding to a highest TFCI decoding quality indicator of the plurality of TFCI decoding quality indicators to act as the derived TFCI content.

10. The method of claim 9, wherein the step of selecting the candidate TFCI corresponding to the highest TFCI decoding quality indicator of the plurality of TFCI decoding quality indicators to act as the derived TFCI content comprises:
checking if the highest TFCI decoding quality indicator is greater than a second highest TFCI decoding quality indicator by a specific threshold; and
when the highest TFCI decoding quality indicator is greater than the second highest TFCI decoding quality indicator by the specific threshold, selecting the candidate TFCI corresponding to the highest TFCI decoding quality indicator of the plurality of TFCI decoding quality indicators to act as the derived TFCI content.

11. A data processing method performed by a Universal Mobile Telecommunications System Frequency Division Duplexing (UMTS-FDD) device, comprising:
generating a control frame and a data frame, wherein the control frame comprises n slots only, and each of q slots of the n slots comprises 2 bits of a transport format combination indicator (TFCI) codeword, where q and n are positive integers and n is greater than q, and the TFCI codeword is encoded from TFCI content for indicating a transport format combination of the data frame; and
transmitting the control frame through a dedicated physical control channel (DPCCH) and the data frame through a dedicated physical data channel (DPCCH).

12. The method of claim 11, wherein the DPCCH is an uplink DPCCH (UL DPCCH) and the DPDCH is an uplink DPDCH (UL DPDCH).

13. The method of claim 11, wherein the DPCCH is a downlink DPCCH (DL DPCCH) and the DPDCH is a downlink DPDCH (DL DPDCH).

14. The method of claim 11, wherein the step of generating the control frame comprises:
generating the TFCI codeword according to the TFCI content; and
dividing the TFCI codeword into a plurality of divided TFCI codewords according to n; and
generating the control frame by only disposing q divided TFCI codewords to q slots, respectively.

15. A data processing method performed by a Universal Mobile Telecommunications System Frequency Division Duplexing (UMTS-FDD) device, comprising:
receiving a control frame from a dedicated physical control channel (DPCCH) and a data frame from a dedicated physical data channel (DPDCH), wherein the control frame comprises n slots only, and each of q slots of the n slots comprise 2 bits of a transport format combination indicator (TFCI) codeword, where q and n are positive integers and n is greater than q, and the TFCI codeword is encoded from TFCI content for indicating a transport format combination of the data frame; and
decoding the data frame according to a derived TFCI content obtained from the control frame.

16. The method of claim 15, wherein the DPCCH is an uplink DPCCH (UL DPCCH) and the DPDCH is an uplink DPDCH (UL DPDCH).

17. The method of claim 15, wherein the DPCCH is a downlink DPCCH (DL DPCCH) and the DPDCH is a downlink DPDCH (DL DPDCH).
